(19) United States
(12) Patent Application Publication
(10) Pub. No.: US 2014/0293025 A1
(43) Pub. Date: Oct. 2, 2014

(54) Method and Apparatus of Assembly and Retention of 3D Glasses

(71) Applicant: Dolby Laboratories Licensing Corporation, San Francisco, CA (US)

(72) Inventor: Julian Farnam, Livermore, CA (US)

(73) Assignee: DOLBY LABORATORIES LICENSING CORPORATION, San Francisco, CA (US)

(21) Appl. No.: 14/220,382

(22) Filed: Mar. 20, 2014

Related U.S. Application Data
(60) Provisional application No. 61/805,265, filed on Mar. 26, 2013.

(51) Int. Cl. G02B 27/22; G02B 27/26; H04N 13/04; G02C 5/14

(52) U.S. Cl. CPC G02B 27/2228; G02C 5/146; G02B 27/26; H04N 13/0459
USPC 348/54; 351/116; 351/121; 359/464; 359/465

(57) ABSTRACT

A 3D projection and viewing system comprising viewing glasses having a frame including a receptacle mechanism on an eyewear frame, the receptacle mechanism configured to receive a corresponding portion attached to a temple part of eyeglasses comprising the eyewear frame. The corresponding portion may be, for example, an insertable snap device that fits into the receptacle mechanism and includes a barb or other latch mechanism that “snaps” into place.

### CROSS-REFERENCE TO RELATED APPLICATIONS

This application is related to U.S. provisional application No. 61/805,265, filed on Mar. 26, 2013, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to 3D glasses and systems for projecting (or displaying) and viewing 3D images.

2. Description of Related Art

Methods for 3D stereoscopic projection include Anaglyph, Linear Polarization, Circular Polarization, Shutter Glasses, and Spectral Separation. Anaglyph is the oldest technology, and provides left/right eye separation by filtering the light through a two color filter, commonly red for one eye, and cyan for the other eye. At the projector, the left eye image is (commonly) filtered through a red filter, and the right image filtered through a cyan filter. The eyewear consists of a red filter for the left eye, and a cyan filter for the right eye. This method works best for black and white original images, and is not well suited for color images.

Linear Polarization 3D provides separation at the projector by filtering the left eye through a linear polarizer (commonly) oriented vertically, and filtering the right eye image through a linear polarizer oriented horizontally. The eyewear consists of a vertically oriented linear polarizer for the left eye and a horizontally oriented polarizer for the right eye. The projection screen must be of the polarization preserving type, commonly referred to as a “silver screen” because of its distinctive color. Linear Polarization allows a full color image to be displayed with little color distortion. It has several problems, these include the need for a silver screen which is expensive, fragile, and not uniform. Another problem is that the viewer must keep his head oriented vertically to avoid crosstalk from one eye to another.

Circular Polarization 3D was invented to address the problem of requiring the viewer to keep his head oriented vertically. Circular Polarization provides separation at the projector by filtering the left eye image through a (commonly) left handed circular polarizer, and filtering the right eye image through a right handed circular polarizer. The eyewear consists of a left handed circular polarizer for the left eye and a right handed circular polarizer for the right eye. A silver screen is also needed for this approach.

Shutter Glasses provides separation by multiplexing the left and right images in time. A filter for separation at the projector is not required. The eyewear consists of Shutter Glasses. These are active glasses that electronically shutter the lens in synchrony with the projector frame rate. The left eye image is first displayed, followed by the right eye image etc. Since having a direct wired connection to the Glasses in a theatre is impractical, a wireless or infrared signaling method is used to provide a timing reference for the left/right eye shuttering. This method requires an IR or RF transmitter in the auditorium. The Shutter Glasses are expensive and hard to clean, require batteries that must be frequently replaced, and are limited in their switching rate. Shutter glasses are only practical for use with D-Cinema or other electronic projection systems since very few film projectors provide the signal required to synchronize the shutter glasses with the frame rate. The method does not require a silver screen.

Spectral Separation provides separation at the projector by filtering the left and right eye spectrally. The system differs from anaglyph in that the filters for the left and right eye each pass a portion of the red, green, and blue spectrum, providing for a full color image. The band pass spectrum of the left eye filter is complementary to the band pass spectrum of the right eye filter. The eyewear consists of filters with the same general spectral characteristics as are used in the projector. While this method provides a full color image, it requires color compensation to make the colors in the left and right eye match the colors that were present in the original image, and there may be a small reduction in the color gamut compared to the gamut of the projector.

All of the above methods for providing left/right eye separation for a 3D Stereoscopic presentation can be used with either two projectors (one for the left eye and one for the right eye), or may be used with a single D-Cinema projector system. In the dual projection system, the projection filter is usually static, and may be located in front of the projection lens or inside the projector. In a single D-Cinema projector system, the left and right images are time multiplexed. Except for the Shutter Glasses case where no projection filters are required, this means that the projection filters must change at the L/R multiplex frequency. This can be done with either a filter wheel in the projector synchronized to the multiplex frequency, or with an electronically switched filter.

### SUMMARY OF THE INVENTION

The present inventor has realized the need for improved glasses for viewing 3D movies and displays. The present invention provides a method and apparatus for attaching a temple portion of glasses in a manner that also secures lenses of the glasses, and which may suitable be synergistically utilized as a component in 3D viewing systems.

The present invention may be realized in a glasses frame including a receptacle mechanism 210 on an eyewear frame 110, the receptacle mechanism 210 configured to receive a corresponding portion 215 attached to a temple part of eyeglasses comprising the eyewear frame. The corresponding portion 215 may be, for example, an insertable snap device that fits into the receptacle mechanism 210 and includes a barb or other latch mechanism that “snaps” into place (e.g., into a groove or other depression on an inner wall of the receptacle mechanism 210) or otherwise locks the corresponding portion in a position relative to the receptacle. The latch mechanism may be, for example, compressed when placed into the receptacle and snap out (and lock) when fully inserted or at a predetermined distance.

The eyeglasses are, for example, 3D glasses. The lenses comprising filters for separating viewing channels of 3D imagery. The viewing channels may be any of polarization, spectral, color, shutter (e.g., time synchronized on/off shutters) or other separation techniques.

In addition to the receptacle and corresponding portion on the temple, the temple also preferably includes a foot 220 that is extended toward and utilized to secure the lenses when the temple is in place. In one embodiment, force from the foot holding the lens in place works together and in conjunction with force applied to the receptacle and corresponding portion at the temple/frame conjunction to hold the temple in its “snapped” position and at the same time hold the lens in position (e.g., pressure from the latch and receptacle and pressure from the feet work together holding the lens, frame, and temple together as a monolithic unit).

The glasses frame and/or temple may include other electronics or RF devices such as RFID, NFC, and anti-shoplifting tags. In one embodiment, at least one of the electronics or RF devices is molded into the glasses frame and/or temple, and may also be a structural member thereof. In one embodiment, at least one of the electronic or RF devices is integrated (and may be a structural member) of either the receptacle, the corresponding portion, or the feet. In one embodiment, at least one of the electronic or RF devices is redundantly installed in both the frames and temple (and may be installed in the receptacle, corresponding portion, and/or feet). The invention further includes inventory control comprising software that may include web based cloud computing and/or storage utilizing or maintaining data from communications between the electronics or RF devices and detectors, smart devices, or other devices installed at venues, storage, or other facilities.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of eyeglasses according to an embodiment of the present invention;

FIG. 2 is a close-up view of an attachment mechanism unattached according to the present invention;

FIG. 3 is a close-up view of an attachment mechanism attached according to an embodiment of the present invention;

FIG. 4 is an overhead view of eyeglasses according to an embodiment of the present invention;

FIG. 5A is a chart illustrating an exemplary set of left and right lens/viewing filter passbands and projection light wavelengths utilized in an embodiment of a 3D laser projection and viewing system according to the present invention;

FIG. 5B is a chart illustrating an exemplary set of left and right lens/viewing filter passbands and projection light wavelengths utilized in an embodiment of a 3D laser projection and viewing system according to the present invention;

FIG. 6 is a drawing illustrating a projector, connectivity, cinema theater, and viewing arrangement of a projection system according to embodiments of the present invention; and

FIG. 7 is a drawing illustrating light sources and modulation for a projector that may be utilized in conjunction with the glasses 100 according to the present invention.

### DESCRIPTION OF THE PREFERRED EMBODIMENTS

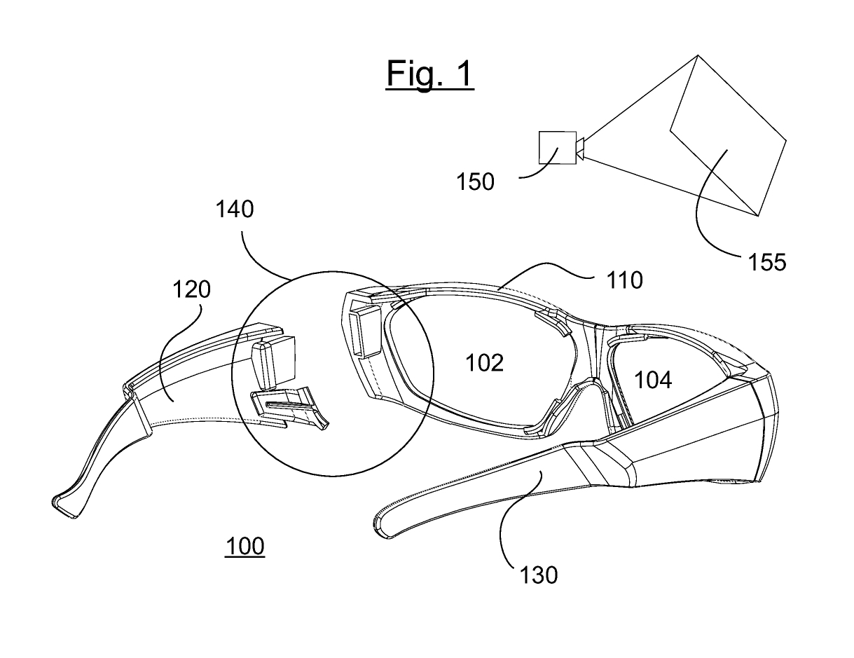

Referring now to the drawings, wherein like reference numerals designate identical or corresponding parts, and more particularly to FIG. 1 thereof, there is illustrated eyeglasses 100 according to an embodiment of the present invention. The eyeglasses are, for example a pair of 3D viewing filters where a lens for each eye is configured to pass a corresponding eye channel image (i.e., left lens passes a left image of a 3D image while excluding the right image and visa versa). The left lens 102 passes wavelengths of light contained in a display of the left image, and the right lens 104 passes wavelengths of light contained in a display of the right image.

A display, such as a television, computer monitor, or cinema projector device (e.g., projector 150 and screen 155) displays a 3D image/images (e.g., left and right view images for each frame of a motion picture) in light having characteristics that pass a corresponding lens/filter of the glasses. The optical properties of the lenses, including filter passbands, shape & curvature of the lens, and arrangement of holding the lenses into a frame 110 of the glasses including the adjoining temples (e.g., left temple 120 and right temple 130) and temple/frame attachment mechanism 140 with other factors of the invention individually improve and cooperate together to produce a visually appealing and comfortable viewing environment.

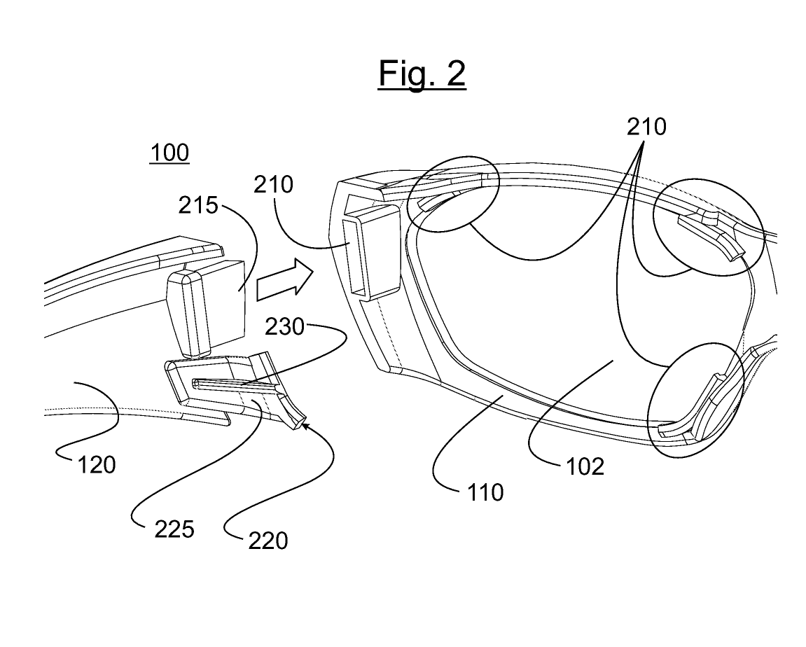

FIG. 2 is a close-up view of an attachment mechanism 140 in an unattached state according to an embodiment of the present invention. A receptacle mechanism which may be, for example, a frame member, hollow chamber, multi-sided guide, or toehr mechanism designed to receive a corresponding portion, flange, or protraction mounted on a temple portion of the glasses (e.g., corresponding portion 215). The corresponding portion 215 slides into or attaches to the receptable mechanism 210. One of the corresponding portion 215 and receptacle mechanism 210 may include a snap and/or ridge for securing them together and thereby mounting and locking the temple to the frame. The snap may be permanent, and with both temples so locked, resulting in a fully assembled pair of 3D viewing glasses. In one embodiment an access point (not shown), such as a hole in a side of the receptacle mechanism allows access for a paper clip wire, rod, or other device so that the snap (e.g., a snap on the corresponding portion that snaps into an indentation or groove (not shown) on an interior wall of the receptacle mechanism) may be retracted and the temple removed.

A foot 220 is provided that extends out and contacts the lens 102 when the temple is mounted to the frame. The lens is retained in position relative to the frame via a combination of lens holding clips 210 and the foot 220. The foot secures a position of the lens 102 holding it firmly in place when the temple is locked into position.

The foot may include, for example, a small amount of padding on a contact point that touches the lens to assure pressure from the foot is evenly applied to the lens from the foot surface. The retaining clip may also include a small amount of cushion or padding for the same purpose. Padding at any of the contact points (e.g., foot, clips, lens/frame contacts) is optional. Typically, the polycarbonate, plastic, or other materials from which the frames may be constructed sufficiently and evenly apply pressure to the components they are in contact with.

The foot may be mounted to the temple via an extension 225. The extension 225 is curved in an amount that places the foot at an edge of the lens 102, and may include a support member 230 that stiffens the extension. When installed, the extension, through the foot, provides an amount of force that firmly holds the lens in place and adds to the rigidity of the temple and frame as a whole. The extension and support member may optionally include an amount of flexibility (and have a spring-like effect) so that the temple may be firmly snapped into place. Inclusion of the support member is optional, but preferred to maintain strength while keeping the material cost down (and less materials being lighter). Whether rigid or having some flexibility, force from the foot and insertion of the receptacle/corresponding portion along with the lens and lens holding clips act together to firmly hold the frame, lenses, and temples together as a single monolithic unit.

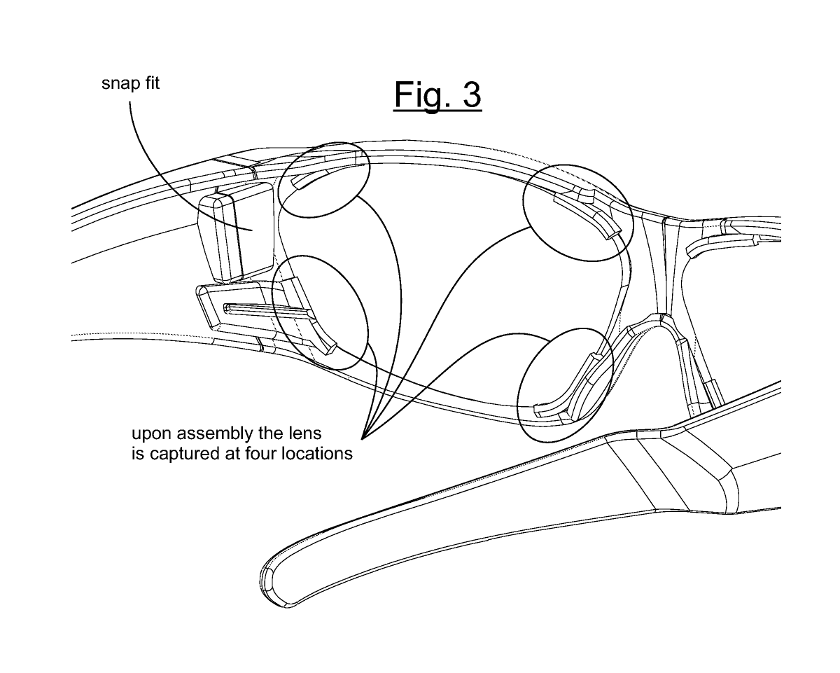

FIG. 3 is a close-up view of an attachment mechanism foot, lens clips and associated parts in an attached configuration according to an embodiment of the present invention. The temple is fitted and locked into position with the receptacle mechanism/corresponding portion. The foot is pressed against the lens which is held in position via lens clips. All parts are held securely in position.

It should be noted that the lens clips as shown retain the lens at three separate positions. However, any number of lens clips may be utilized (4, 5, 6, or more lens clips would not be impractical), and the lens clips themselves may be larger or smaller than those illustrated. Typically, the lens clips are installed at locations that distribute retaining forces to the lenses (e.g., equidistant locations, one per side, two per side, etc.) taking into account the foot contact area. The illustrated embodiments show lens clips at locations selected to efficiently and cost effectively retain the lenses.

In one embodiment, a single lens clip on an opposite side of the lens is utilized, and the foot presses the lens into the frame and the opposite side lens clip. In one embodiment, the lens clip may be elongated to cover an entire edge of the lens (e.g., a lens clip that clips over the nose bridge edge of the lens). In one embodiment, a single lens clip partially surrounds the lens (except where contacted by the foot). In one embodiment, a single lens clip encompasses nearly the entire lens. In one embodiment, the lens clip is aligned with the foot such that when installed, the foot presses on the lens clip which then in turn presses on the lens (this arrangement allows a wider lens clip to distribute foot pressure over a wider area of the lens). Each of the specific lens clips arrangements may be used in combination with the other technologies described herein (e.g., receptacle, extensions, feet, etc.)

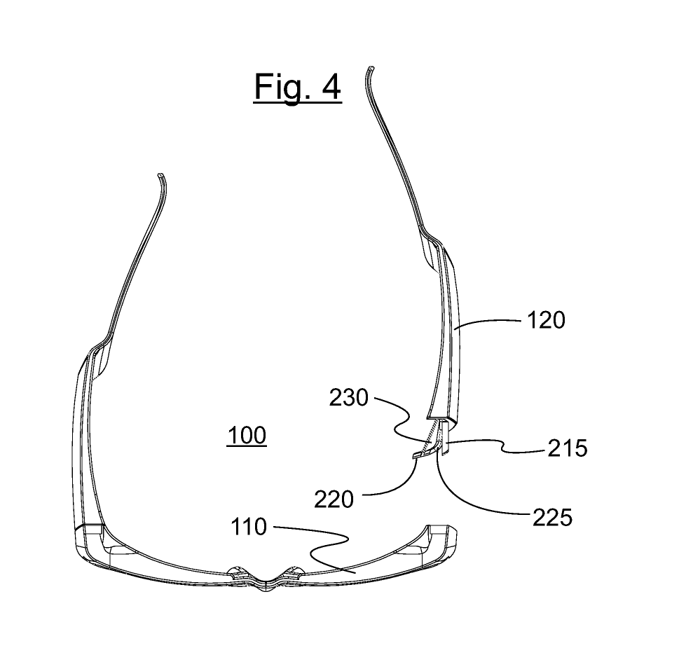

FIG. 4 is an overhead view of eyeglasses 100 in an un-secured configuration according to an embodiment of the present invention. Temple 120 is separated from frame 110. The temple 120 includes the corresponding portion 215, foot 220 and extension 225. The extension 220 includes support member 230.

The projection system 150 may be, for example, a wide band cinema projector or a narrowband projector, or a laser projector. The projection may be spectrally separated (different portions of red, blue, and green spectrum for each eye channel or image), polarization separated (e.g., S & P polarized light respectively used to produce 1^{st} and 2^{nd} channel images, one image for each eye channel per frame), anaglpyh (e.g., long wavelength 1sts channel and short wavelength 2^{nd} channel). Depending on the type of projection (whether from a traditional movie projector or a television or computer display) appropriately matched lenses are provided for the glasses 100 (e.g., the left eye lens passing the 1^{st} or 2^{nd} channel and the right eye lens passing the other channel).

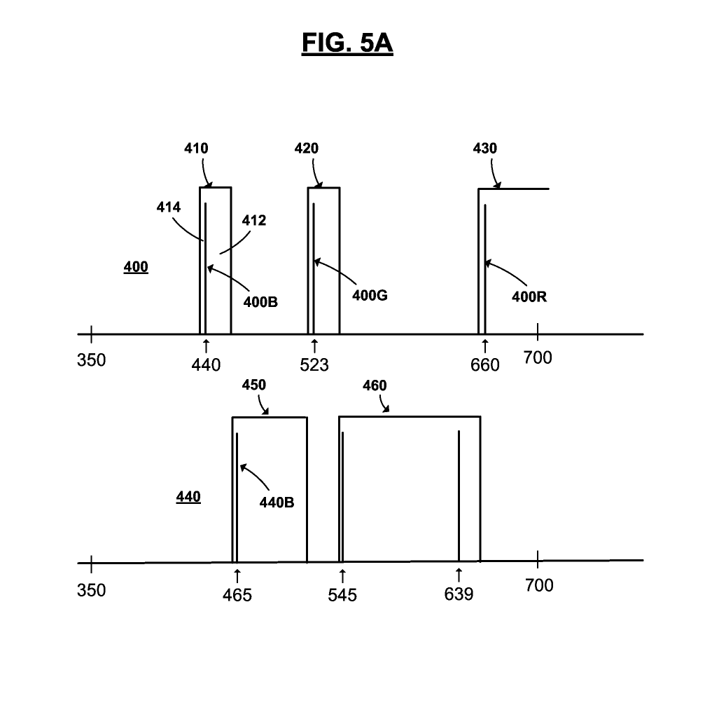

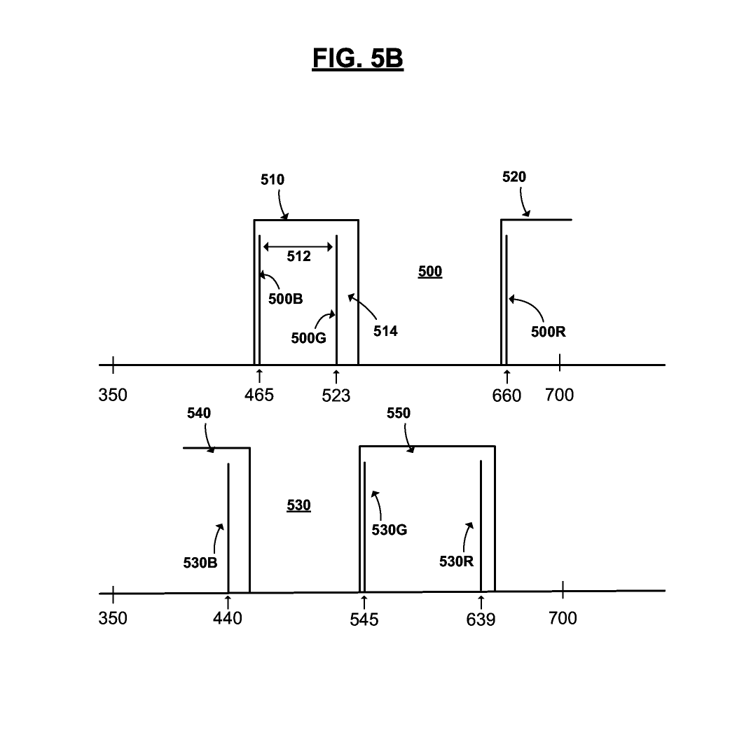

In one embodiment, the projector 150 is a laser projector and may have laser light sources comprising red, green, and blue wavelength light sources. FIG. 5A is a chart illustrating an exemplary set of left and right lens/viewing filter passbands and projection light wavelengths that may be utilized by a projector 150 and glasses 100 according to an embodiment of a 3D laser projection and viewing system according to the present invention. The passbands are constructed, for example, using interference filters on lenses of the glasses 100.

A first channel 400 comprises, for example, red, green, and blue lights. The blue light 400-B may be, for example, a laser light source of 440 nm wavelength. The green light 400-G may be, for example, a laser light source of 523 nm. The red light source may be, for example, a laser light source of 660 nm.

The R-G-B lights are, for example, respectively passed bu passbands/pass areas 410, 420, and 430. Each of the passbands allow for passing of corresponding lights of the same channel to pass while rejecting lights of the opposite channel.

The second channel 440 also includes passband 460 which is specifically configured to pass multiple lights (e.g., green—545 and red—639 lights). The passband 460 may include shifting passbands/passareas for viewing the light off-axis through a filter constructed using the passband 460. The passband 460 may be adjacent to an open-ended passband (e.g., high pass filter, passband/passarea 430) in an opposite channel. In some embodiments, both channels may include passbands configured to pass multiple lights (e.g., 2 different laser lights, or 3 or more different wavelengths of laser light).

FIG. 5B is a drawing illustrating laser/narrowband lighting and viewing passbands that may be utilized in filters/lenses of glasses according to the present invention. A first channel 500 comprises pass areas that may be utilized in a filter for passing blue light 500-B (e.g., 465 nm), green light 500-G (e.g., 523 nm), and red light 500-R (e.g., 660 nm). A first area of the first channel comprises passband 510 which is specifically configured to pass both the blue and green lights 500-B and 500-G with separate shifting passband areas (e.g., shift bands 512 and 514) contained within the same passband. Both shift band areas are sufficient for off-axis viewing of the blue and green lights at angles normally encountered at a venue where images created using those lights are produced. The passband 510 is also sufficiently small and/or guarded such that the same off-axis incident/viewing of lights from 2^{nd} channel 530 are blocked. A second pass 520 area of the first channel is specifically configured to pass red light 500-R and have a sufficient shift pass area for viewing red light 500-R off-axis.

A second channel 530 comprises pass areas that may be utilized in a filter for passing blue light 530-B (e.g., 440 nm), green light 530-G (e.g., 545 nm), and red light 530-R (e.g., 639 nm). A first pass area 540 of the second channel is specifically configured to pass blue light 530-B and have a sufficient shift pass area (shifting passband) for viewing light 530-B off-axis.

A second area of the second channel comprises passband 550 which is specifically configured to pass both the green and red lights 530-G and 530-R with separate shifting passband areas contained within the same passband. Both shifting passband areas are sufficient for off-axis viewing of the blue and green lights at angles normally encountered at a venue where images created using those lights are produced. The passband 550 is also sufficiently small and/or guarded that the same off-axis viewing of lights from 1^{st} channel 500 are blocked.

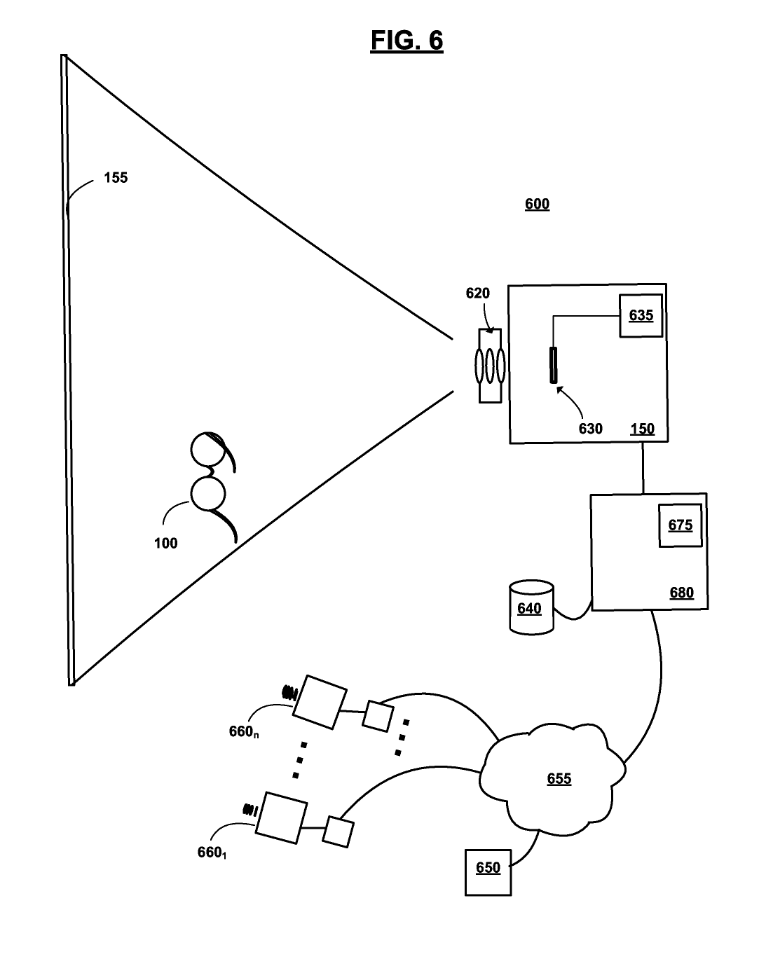

FIG. 6 is a drawing illustrating a projector, connectivity, cinema theater, and viewing arrangement of a projection system 600 that may be utilized with appropriately configured glasses 100. The projection system 600 includes a digital cinema laser projector 605 that projects spectrally separated 3D images (a left channel image and a right channel image) modulated by modulator 630 and projected by projection lens 620 onto a screen 610 for viewing with glasses 100. Glasses 100 include, for example, spectrally separated filters disposed as coatings on each lens of the glasses such that the right lens comprises a filter that matches or encompasses the passbands of the right channel filter and the left lens comprises a filter that matches or encompasses passbands of the left channel filter (each of the left and right channel images are intended to be viewed by a viewer's corresponding left or right eye through the corresponding left or right eye lens/filter of the glasses) that are configured to pass laser lights. In various embodiments, the laser lights are passed at blue ends of passbands for each light and the passbands include a shifting passband for viewing the lights off-axis.

The filters are constructed, for example, via layered materials, films, and/or deposits, and may be disposed on a substrate. The layered materials may comprise layers that alternate between a layer of a relatively high index of refraction and a layer of relatively lower index of fraction. The thickness of the layers may also vary. The substrate, if applicable, may be glass, plastic, a polycarbonate, or another material. The substrate may be one of the layers. In one embodiment, the filter is a layered polycarbonate, plastic, or plastic like material without an underlying substrate material.

The projector 605 may receive, for example, image data for projection from a server 680. 3D content may be provided to the server 680 from, for example, a disk drive 640. Alternatively, 3D content may be transmitted to projector 605 over a secure link of network 655 from, for example, an image warehouse or studio 650. Multiple other projectors (e.g., at theaters around the globe, 660₁. . . 660n) may also feed from similar network or other electronic or wireless connections including wireless networks, satellite transmission, or quality airwave broadcasts (e.g., High Definition, Wide Color Gamut, High Dynamic Range, or better broadcast).

The server 680 may include a color correction module 675 that performs mathematical transformations of color to be reproduced by the projector prior to image projection. The mathematical transformations utilize image data for each of the left and right channels and transform them into parameters consistent with the primary colors or passbands of the corresponding left or right channel filter. The mathematical transformation, or color corrections, adjust the hue of each image and maximize the available color space and match the color space and white point of projector 705 as closely as possible. The color corrected 3D content is transmitted to projector 605. The 3D content includes left and right channel images that switch at a rate fast enough that they blend into a single 3D image when viewed by a viewer through glasses 100.

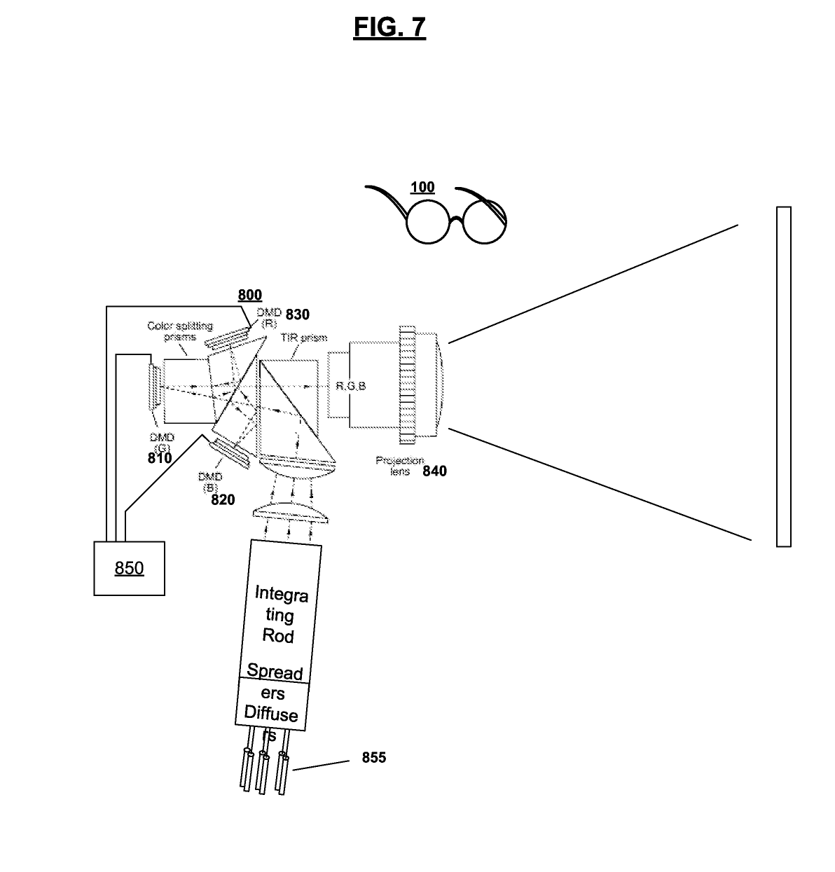

FIG. 7 is a drawing illustrating light sources and modulation for a projector that may be utilized in conjunction with the glasses 100. A modulator 800 comprises a series of prisms that direct incoming light to an appropriate modulator (DMD modulators in this example) for modulation. In this example, modulator 800 utilizes a system of prisms 805 to direct green light to a “green” DMD modulator, blue light to a “blue” DMD modulator, and red light to a “red” DMD modulator. The prisms also function to re-combine the now modulated light and a projection lens 840 projects the modulated lights for display.

Each modulator is controlled, for example, by a processor 850 that includes programming to provide appropriate image data (including color correction from matching colors of left and right channel 3D images) to energize each of the DMD modulators.

A light source 855 may comprise narrowband light sources (e.g., as described above in reference to FIGS. 5A and 5B). In the illustrated embodiment, the light sources comprise 6 laser light sources (2 red, 2 green, and 2 blue). For a 3D system, the light sources provide the ability to produce a first channel image having first spectral characteristics and a second channel image having second spectral characteristics complimentary to the first spectral characteristics (complimentary in the sense that the red, green, and blue wavelengths of the first channel are, for example, different/separate from the red, green, and blue wavelengths of the second channel).

For example, the light sources may alternate between illuminating the modulator 800 with RGB lights from the first channel and then with RGB lights from the second channel and so on. Processor 850 energizes the DMD modulators (separate “red,” “green,” and “blue” DMD's in the exemplary modulator 800) with image data corresponding to the first channel during time periods it is illuminated with the RGB lights for the first channel and then with image data corresponding to the second channel during time periods it is illuminated with RGB lights for the second channel.

3D glasses according to the invention are suited for delivery as a set of glasses to a theater, cineplex, or other venue and may include spare parts including at least one of a set of spare temples, spare lenses, and spare frames. The 3D glasses may be part of cinema projector system comprising a laser projector configured to project left and right perspective images of a 3D image. The cinema projector system may comprise, for example, a cinema content link comprising a high bandwidth data transfer system configured to receive 3D movie content for display by the cinema projector system.

The glasses are packaged in its separate components and shipped to a customer, which may be a cinema or individual movie enthusiasts. The separate components may comprise, for example, at least two of temples, frames, and lenses. The packaged glasses may be movie themed comprising at least one of frames and temples that are movie themed. In addition or alternatively, the packaged glasses are a platform for advertising material such as company logos or websites.

Any of the embodiments may also include a release mechanism that allows easy disassembly of the glasses. The release mechanism may be tool free, but preferably requires a special tool such as the aforementioned rod or pin. As illustrated in the figures, the 3D glasses are snap fit and the frames, temples, and lenses fit together without screws. Preferably, in all embodiments, the frames, temples, and lenses are constructed from materials that withstand on average more than 1,000 wash cycles.

3D glasses according to the invention may include where interior surfaces of the glasses frames and temple portions (mainly temple portions and frame portions near the eye) are coated with anti-reflection coatings having peak absorption at light properties (e.g., wavelengths, polarization, or other property) similar to that passed by the corresponding eye filter (e.g., frame and temple at or around the left eye filter having peak absorption with respect to properties of the left eye filter or lens).

The snap device is, for example, a permanent snap such that the glasses cannot be disassembled without breaking the frame or temple. The the temple snaps into the glasses frame via the snap device on the temple and a ridge (or groove/ledge) in a receptacle means on the frame when the snap is inserted into the temple.

The foot may be attached to an extension from the temple and the extension comprises a curved extension placing the foot at the lens when assembled together with the frame, said extension comprising a supporting structure that stiffens the foot. The supporting structure may be thinner than the extension and molded into the extension such that the extension and supporting member together are rigid single piece than either separately and the supporting member adds thickness in at least one dimension of the combined structure. The supporting structure may be designed and arranged, for example, as illustrated in FIG. 2. The assembled glasses may be substantially similar to the glasses illustrated in any of FIGS. 1, 2, 3, and 4, and the component parts may comprise the component parts illustrated in any of FIGS. 1, 2, 3, and 4.

In describing embodiments of the present invention illustrated herein and in the drawings, specific terminology is employed for the sake of clarity. However, the present invention is not intended to be limited to the specific terminology so selected, and it is to be understood that each specific element includes all technical equivalents which operate in a similar manner. For example, when describing a filter (e.g., pass filters as shown in the figs., interferences filters, color filters, etc.) it should be understood that any other equivalent device or a device having the an equivalent function or capability, whether or not listed herein, may be substituted therewith. Furthermore, the inventor recognizes that newly developed technologies not now known may also be substituted for the described parts and still not depart from the scope of the present invention. All other described items, including, but not limited to displays, projectors, filters, lenses, attachment or retaining mechanisms, clips, extensions, feet, cushioning, radiometric devices, software, storage, communications, etc. should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, the preparation, correction (e.g., color) of images or other data, and the display, storage, or communication of results according to the processes of the present invention.

The present invention may suitably comprise, consist of, or consist essentially of, any of element (the various parts or features of the invention and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of claims to be included in a subsequently filed utility patent application, the invention may be practiced otherwise than as specifically described herein.

By way of further examples, in various embodiments, the invention comprises, and may be embodied, as, for example:
3D glasses having lenses held into place on a frame of the glasses using a combination of a retaining mechanism on the frame and at least one retaining mechanism on a temple of the glasses. The retaining mechanism on the frame may be, for example, clips that provide a ledge over an inside surface of the glasses, such that during assembly of the glasses a lens may be inserted between the frame and the ledge. The retaining mechanism on the temple may comprise, for example, a foot extended from the temple and configured to apply force to the lens in a manner that retains the lens between the frame and the ledges. The temple may include a guide mechanism comprising, for example, a receptacle mounted to the frame (or alternately the temple) and a corresponding member configured to be inserted into the receptacle and a snap portion retaining the corresponding member in the receptacle.

1. 3D glasses having lenses held into place on a frame of the glasses using a combination of a retaining mechanism on the frame and at least one retaining mechanism on a temple of the glasses.

2. The 3D glasses according to claim 1, wherein the retaining mechanism on the frame comprises clips that provide a ledge over an inside surface of the lenses, such that during assembly of the glasses a lens may be inserted between the frame and the ledge.

3. The 3D glasses according to claim 2, wherein the retaining mechanism on the temple may comprise, for example, a foot extended from the temple and configured to apply force to the lens in a manner that retains the lens between the frame and the ledges.

4. The 3D glasses according to claim 3, wherein the temple may include a guide mechanism comprising, for example, a receptacle mounted to the frame (or alternately the temple) and a corresponding member configured to be inserted into the receptacle and a snap portion retaining the corresponding member in the receptacle.

5. The 3D glasses according to any of claim 1, wherein the 3D glasses are part of 3D projection and viewing system comprising a 3D laser projector configured to project 3D images for each of a first and second viewing channel wherein a first lens of the glasses comprises a filter corresponding to and passing light of the 1^{st} channel and a second lens of the glasses comprises a filter corresponding to and passing light of the 2^{nd} channel.

6. The 3D glasses according to claim 5, wherein the 1^{st} and 2^{nd} channel comprise one of light polarized for its corresponding channel and spectral separation comprising light wavelengths spectrally separated from each other and wavelengths of the other channel.

7. The 3D glasses according to claim 5, wherein the 1^{st} and 2^{nd} channels comprise spectrally separate channel and the lenses comprise filters that are red shifted relative to wavelengths of light passed by the filters.

8. The 3D glasses according to claim 6, wherein the snap fitted temple, frame, lens, and lens clips together form a monolithic like structure.

9. The 3D glasses according to claim 6, wherein a set of glasses delivered to a theater, Cineplex, or other venue include spare parts including at least one of a set of spare temples, spare lenses, and spare frames.

10. The 3D glasses according to claim 6, wherein the glasses are part of cinema projector system comprising a laser projector configured to project left and right perspective images of a 3D image.

11. The 3D glasses according to claim 10, wherein the cinema projector system comprises a cinema content link comprising a high bandwidth data transfer system configured to receive 3D movie content for display by the cinema projector system.

12. The 3D glasses according to claim 5, wherein the glasses are packaged as separate components and shipped to a customer.

13. The 3D glasses according to claim 12, wherein the separate components comprise at least two of temples, frames, and lenses.

14. The 3D glasses according to claim 12, wherein the packaged glasses are movie themed comprising at least one of frames and temples that are movie themed.

15. The 3D glasses according to claim 12, wherein the packaged glasses are a platform for adding advertising material such as company logos or websites.

16. The 3D glasses according to claim 5, further comprising a release mechanism that allows easy disassembly of the glasses into its component pieces.

17. The 3D glasses according to claim 5, wherein the frames, temples, and lenses fit together without screws.

18. The 3D glasses according to claim 5, wherein the frames, temples, and lenses are constructed from materials that withstand on average more than 1,000 wash cycles.

19. The 3D glasses according to claim 4, wherein the snap portion is a permanent snap such that the glasses cannot be disassembled without breaking the frame or temple.

20. The 3D glasses according to claim 4, wherein the assembled glasses comprise a configuration that is not user disassembly friendly such that at least one of tools and preferably special tools are required for disassembly without breakage.
